(19) United States
(12) Patent Application Publication
(10) Pub. No.: US 2018/0141328 A1
(43) Pub. Date: May 24, 2018

(54) Decorating Device

(71) Applicant: Shanghai EKe Creative & Cultural Development Holdings Co., Ltd., Shanghai (CN)

(72) Inventor: Jiyu Chen, Shanghai (CN)

(21) Appl. No.: 15/654,979

(22) Filed: Jul. 20, 2017

(30) Foreign Application Priority Data
May 20, 2016 (CN) 201620461691.X

(51) Int. Cl. B41G 7/00

(52) U.S. Cl. CPC B41G 7/003

(57) ABSTRACT

A decorating device having a charging point and a stamping plate main body is disclosed. The stamping plate main body is detachably installed on the charging point and comprises a heating plate, and a cover plate. The device is adapted to receive a stamping template and a foil laid from the bottom to the top in order between the heating plate and the cover plate. The stamping plate main body is dimensioned to fit a stamping, cutting or embossing press.

### CROSS-REFERENCE TO RELATED APPLICATION

This application claims priority from and the benefit of Chinese Patent Application No. 201620461691.X, filed on May 20, 2017, which is hereby incorporated by reference for all purposes as if fully set forth herein.

### FIELD OF THE INVENTION

The embodiments relate to a decorating device.

### BACKGROUND

Foil stamping is the process of stamping hot foil, such as metallic foil, from a template onto a surface of printing stock or other materials. The process uses the principle of hot-pressing transfer to transfer the pattern of the template from the foil to the printing stock, with pressure and heat applied to the template, foil and printing stock causing the hot foil to attach to the printing stock.

Such foiling techniques, particularly those which may be used at home, are increasing in popularity.

An existing technique may involve a hot plate and press for foiling. However, with this device, it is necessary to buy the entire press and hot plate, at considerable cost.

In many instances, a consumer interested in such hot foiling techniques may own a press used for one or more of cutting, embossing or stamping.

### SUMMARY

It is desirable to provide a foil stamping device where it is easier to remove the template, thereby potentially contributing to the practicality and reliability, and cost-effectiveness of such devices.

It is further desirable to provide a decorating device whereby hot foiling could be accomplished with pre-existing or pre-owned presses.

A decorating device, comprising a charging point and a stamping plate main body, wherein said stamping plate main body is detachably installed on the charging point and comprises a heating plate, and a cover plate, said device being adapted to receive a stamping template and a foil laid from the bottom to the top in order between the heating plate and the cover plate wherein said stamping plate main body is dimensioned to fit a stamping, cutting or embossing press.

The decorating device may comprise an insulating layer attached to the stamping plate main body situated between the heating plate and the cover plate.

The stamping plate main body may have a height between 20 mm and 32 mm, and a width between 80 mm and 240 mm. In an embodiment, the height is between 20 mm and 25 mm. In an embodiment, the width is between 130 and 160 mm. In an embodiment, the height is 22 mm. In an embodiment, the width is 150 mm.

It has been found that these dimensions allow the stamping plate main body to be used with pre-existing or pre-owned stamping, cutting or embossing presses.

One or both of said stamping plate main body and said cover plate may have a grid. A grid allows the user to accurately align any templates and foil, thereby resulting in a more efficient foiling e.g. by using less foil. The grid of the stamping plate main body may be formed on the insulating layer. The heating plate may comprise one or more heating elements. The heating elements may be wires. In an embodiment, the heating elements are surrounded in a heat dissipating material. In a further embodiment, the heating plate is a planar member formed from metal or other heat conducting material.

The cover plate may be detachably connected to the stamping plate main body.

The cover plate may be connected to the stamping plate main body by a hinge.

The device may further comprise a charging base having said charging point.

A surface of said charging base may be formed with an accommodating space for accommodate the stamping plate main body, an inner wall of a side of said accommodating space is provided with an insertion groove structure for receiving the heating plate of the stamping plate main body.

One end of the stamping plate main body may be provided with an insertion tenon structure engaged with the insertion groove structure, said insertion tenon structure being provided with a pin for rotationally connecting the heating plate to the cover plate.

One end of said cover plate may be provided with a convex structure which matches the gap between two adjacent insertion tenon structures, and the bottom of said convex structure may be further provided with an axle hole for rotationally receiving the pin.

The convex structure (241) may be formed downwardly from a plane of the cover plate.

The device may comprise a hinge, wherein said hinge is arranged to engage with said charging base when in an open position to thereby lock the stamping plate main body to the charging base.

In order to be used with certain pre-existing presses, the decorating device of embodiments may be supplied with one or more shims. The shims may be of varying thickness, but in an embodiment are 0.34 mm thick. In an embodiment, cardboard is used as a shim.

The hinge may comprise a pin and a corresponding convex structure which engages with the pin.

The charging base may be provided with an on-off button.

The charging base may be further provided with an indicator light to indicate when the charging base is connected to a mains power.

The charging base may be further provided with a power supply interface.

The heating plate may comprise a silica gel plate provided with a heating wire therein, wherein silica gel of said silica gel plate is molded about said heating wire.

### BRIEF DESCRIPTION OF THE DRAWINGS

FIG. 1 illustrates a structural view of a decorating device according to an embodiment.

FIG. 2 illustrates an exploded view of the decorating device of FIG. 1.

FIG. 3 illustrates an exploded view of the decorating device of FIG. 1.

FIG. 4 illustrates an exploded view of the decorating device of FIG. 1.

FIG. 5 illustrates a schematic view of a heating plate used with the decorating device of FIG. 1.

FIG. 6 illustrates a front view of the stamping plate main body of the decorating device of FIG. 1.

FIG. 7 illustrates a schematic view of a press.

FIG. 8 illustrates a top view of a heating pad of the decorating device of FIG. 1.

### DETAILED DESCRIPTION

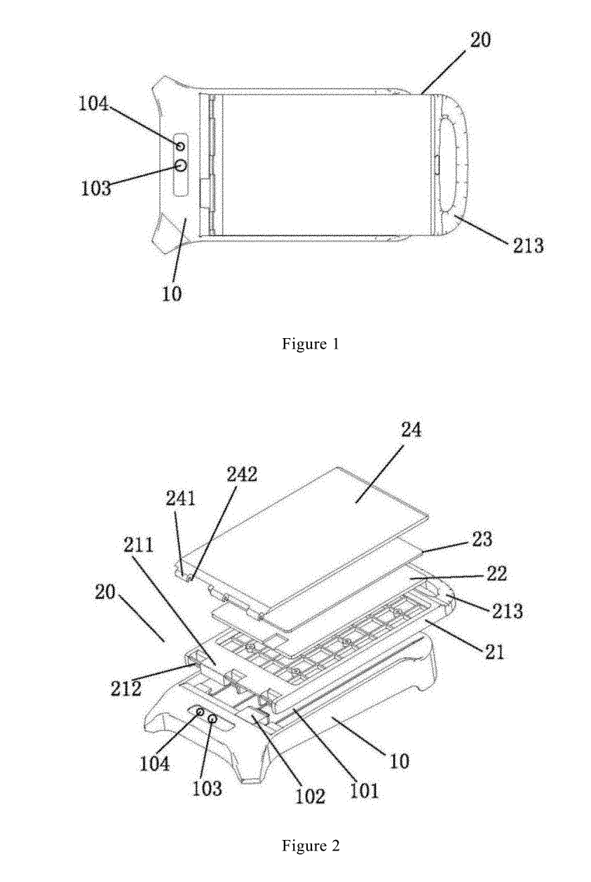

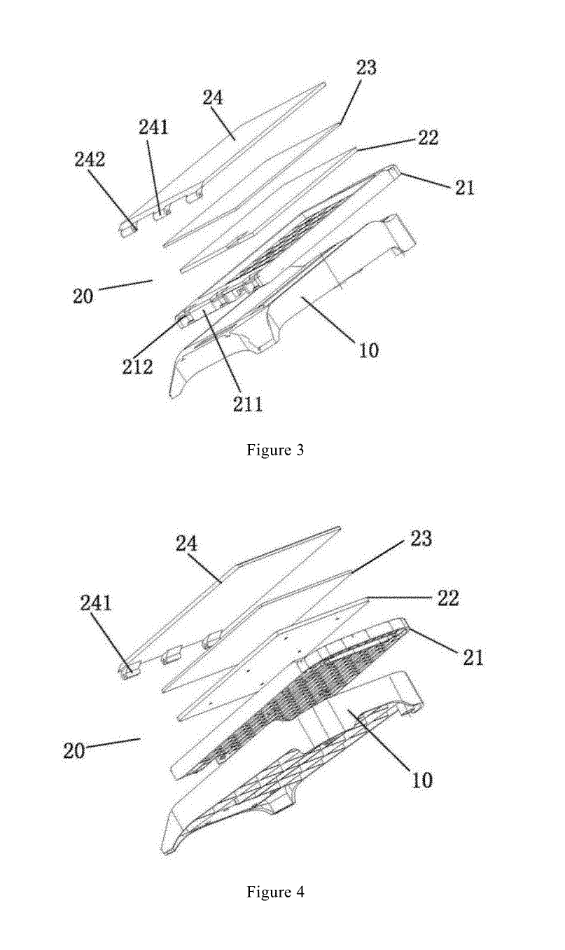

As shown in FIGS. 1 to 4, the decorating device comprises a charging base 10 and a stamping plate main body 20, the stamping plate main body 20 is detachably installed on the charging base 10 and comprises a heating plate 22, an optional insulating layer 23 and a cover plate 24, and is adapted to receive a stamping template and a foil which can be sequentially laid from the bottom to the top between the insulating layer 23 (or the heating plate 22 if no insulating layer is provided) and the cover plate 24. The foil is made of metal foil or pigment foil material and functions primarily as printing color. The stamping template transfers a metallic or other stamping pattern to the corresponding material by the foil.

In the embodiment illustrated, the insulating layer is comprised of silicon, but other materials may be used. The insulating layer 23 serves to protect the foil and stamping template (foil and stamping template not shown) from the direct heat of the heating plate 22. The insulating layer 23 further serves to provide a surface which can withstand the heat from the heating plate 22, but also provides a registration surface for the template or other stencil. The heating plate 22 on the bottom layer of the stamping plate main body 20, the cover plate 24 on the top layer, the stamping template and the foil (not shown) sandwiched there between form a sandwich structure. The stamping template and the foil sandwiched there between are both designed separately from the stamping plate main body 20, so replacement of the stamping template and the foil is convenient, and operability is enhanced.

It is to be realized that the charging base 10 serves to heat the heating plate 22 in the embodiment illustrated. In a further embodiment where the stamping plate main body 20 is provided with a battery, the charging base 10 serves to charge the battery. In a further embodiment, the charging base 10 is replaced by a charging point comprising an electrical connection. This charging point may be provided with charging by induction.

The charging base is provided with an automatic cut-off so that heating is discontinued after a predetermined time, such as 25 minutes to avoid overheating and waste if a user forgets to disconnect the power.

The surface of the charging base 10 is provided with an accommodating space 101 for accommodating the stamping plate main body 20, the inner wall of a side of the accommodating space 101 is provided with an insertion groove structure 102 for charging the heating plate 22 of the stamping plate main body 20. The charging base is provided with an on-off button 103, an indicator light 104 and a power supply interface. The charging base 10 displays a red light during heating time and a green light will be turned on instead when the heating plate 22 is heated to a predetermined temperature.

The insulating layer 23 and heating plate 22 are housed in a housing 21, which also forms part of the stamping plate main body 20.

One end of the housing 21 is provided with an insertion tenon structure 211 which is engaged with the insertion groove structure 102. The insertion tenon structure 211 is provided with a pin 212 for rotationally connecting to the cover plate 24. The other end of the housing 21 is provided with a handle 213 for facilitating the user's grip.

The heating plate 22 is a silica gel plate provided with heating wires therein, the heating wires and the silica gel plate are integrally molded. The design makes the heating plate safe and durable, and has an evenly distributed heating surface.

One end of the cover plate 24 is provided with a convex structure 241 which matches the gap between two adjacent insertion tenon structures 211. The bottom of the convex structure 241 is further provided with an axle hole 242 with an opening for rotation of the pin 212. The convex structure 241 is bent downwardly along the plane of the cover plate 24. As the cover plate 24 is opened, the convex structure 241 on the cover plate 24 will be engaged with the charging base 10 and limits the insertion position of the housing 21, thereby aiding positioning, so to ensure that the stamping plate main body is easier to insert into the charging base 10, and also to avoid sparks which may be caused by improper insertion. This also serves to lock the cover to the charging base, preventing removal of the stamping plate main body 20 when the cover is open. Further, the convex structure 241 bent downwardly reserves a gap between the insulating layer 23 and the cover plate 24 for laying the stamping template the foil and the printing stock. When the material required for stamping is thin, shims in the form of multi-layer pad paper can be sandwiched as required to achieve a required height.

When used specifically, the stamping template, the foil and the printing stock (such as paper, leather, cloth, etc., not shown here) are laid on the insulating layer 23 in order, and the cover plate 24 is covered. After the assembling being completed, the stamping plate main body 20 is inserted into the insertion groove structure 102 on the charging base 10 to be charged and heated, the indicator light 104 displays red color. The initial heating time of the stamping plate main body 20 takes 5 minutes, the subsequent heating time takes 1 to 2 minutes, and the heating temperature is controlled between 80 to 90° C. When the heating is completed, the indicator light jumps to green color, so the user can separate the stamping plate main body 20 from the charging base 10, and place the heated stamping plate main body into a molding press for mold pressing. After high temperature and extruding process, the foil adheres to the foil stamping pattern on the printing stock (paper or leather or cloth and other materials). After mold pressing, the stamping plate main body 20 is removed and opened, the printing stock including foil stamping is removed, as are the stamping template and the foil.

As required, foil stamping templates with different foil stamping patterns and corresponding foils can be selected. The foil stamping device can achieve foil stamping, concave and convex hot-pressing and/or cutting and other functions after heated. When the decorating device does not need to be heated, the concave and convex mold on the stamping template can realize the mold pressing and die cutting function on the paper, leather, cloth and other materials; when the ink is rolled on the foil stamping template, it will realize the printing function of the paper, leather, cloth and other materials; the stamping template can also cooperate with cutting die placed in the accommodating space for double-sided molding, die cutting or printing of the paper, leather, cloth and other materials. The decorating device can be used in conjunction with various sizes of molding presses, any stamping template and cutting die with foil stamping (foiling) function, which has broad application prospect.

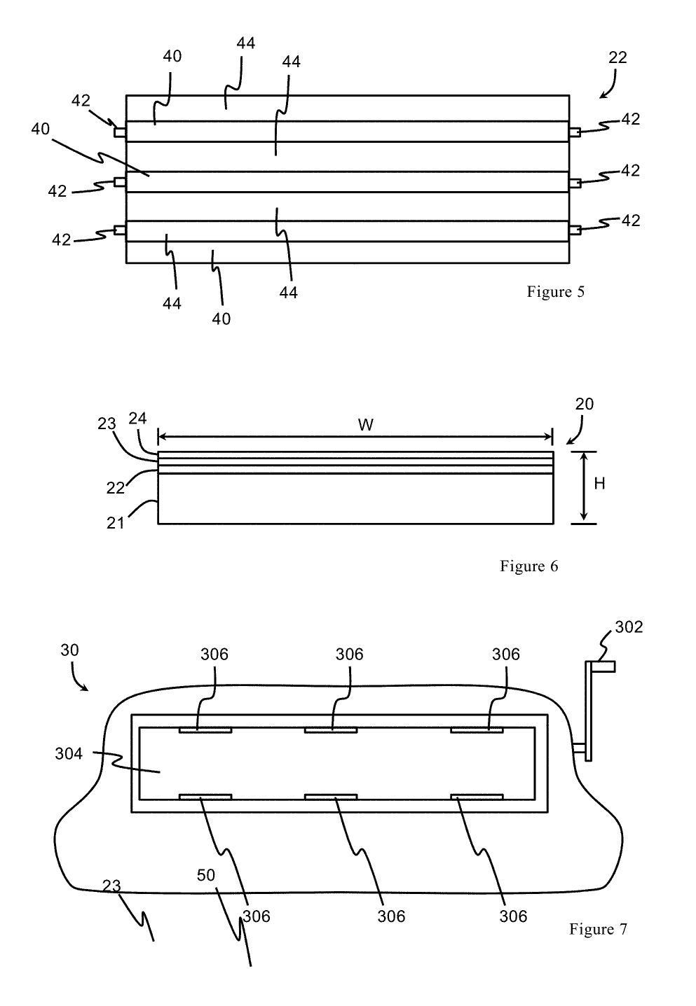

FIG. 5 illustrates a schematic view of a heating plate 22 of the decorating device of FIG. 1. The heating plate 22 comprises three heating elements 40 which are, in this embodiment, in the form of heating wires which are embedded in a silica gel 44. The silica gel 44 allows the heat to dissipate, thereby providing a more even heating surface than provided by direct contact between the heating element and the foil. In an embodiment, although not illustrated here, an insulating material covers the heating elements to avoid the transfer of heat to the electronics or other undesirable portions of the device.

The heating plate comprises a thermostat which determines the temperature at which the heating elements are heated to, before disconnecting the power. Further electronics ensures that the heating elements are not connected for longer than 25 minutes to save power and prevent unnecessary use of the device. In an alternative embodiment, the device comprises a manual thermostat whereby a user may set the temperature manually.

When the heating plate 22 is connected to a power source by means of the charging base 10, a capacitor (not shown here) is charged. When the stamping plate main body 20 is removed from the charging base 10, the capacitor discharges and provides the energy to maintain heat in the heating elements 40. This helps to ensure that a constant (or close to constant) temperature can be maintained while the heating elements are disconnected from a power source. In an alternate embodiment, the stamping plate main body comprises a battery which provides the power to the heating elements when they are disconnected from a mains power source.

Since the decorating device of embodiments of the invention is limited in its dimensions to fit pre-purchased or pre-existing presses, it may be important that the silica gel (or other substrate) provide sufficient heat dissipating and retention qualities.

In a further embodiment, the stamping plate main body comprises a battery, said battery providing power to a heating element.

FIG. 6 illustrates a front view of the stamping plate main body 20 of the decorating device of FIG. 1. As illustrated, the dimensions of the stamping plate main body comprise a height H and a width W. The height H is the height measured with the stamping template 22 and foil 23 installed between the heating plate 22 and the cover 24. The stamping plate main body 20 has a width W.

In embodiments, the height is sufficiently small to ensure that the stamping plate main body, once removed from the charging base or point, can be used with pre-existing or pre-owned presses. It is to be realized that there may be a practical minimum to the height determined by the requirements to include a heating element with the stamping plate main body 20. Similar considerations apply to the width.

The stamping plate main body may have a height between 20 mm and 32 mm, and a width between 80 mm and 240 mm. In an embodiment, the height is between 20 mm and 25 mm. In an embodiment, the width is between 130 and 160 mm. In an embodiment, the height is 22 mm. In an embodiment, the width is 150 mm.

FIG. 7 illustrates a pre-existing or pre-owned press 30. The press 30 includes a void 304 shaped to receive a stamping, cutting or embossing caddy. Such presses are well known in the field and examples include the following presses:

Cuttlebug® die cutting and embossing;

GoCut and Emboss® die cutting and embossing machine by Couture Creations;

Cut'n Go Pro® die cutting and embossing machine by Ultimate Crafts;

Platinum® die cutting and embossing machine by Spellbinders;

Ebosser® die cutting and embossing machine by Craftwell; and

Sizzix Big Shot® die cutting and embossing machine by Sizzix.

A plurality of rollers 306 exert pressure on the caddy when the handle 302 is rotated. Since the stamping plate main body 20 of embodiments of the invention is dimensioned to fit the press 30, advantageously, embodiments of the invention may be used with presses which were originally intended to be used for embossing, cutting or stamping.

In order to be used with pre-existing presses, the decorating device of embodiments may be supplied with one or more shims. The shims may be of varying thickness, but in an embodiment are 0.34 min thick. In an embodiment, cardboard is used as a shim.

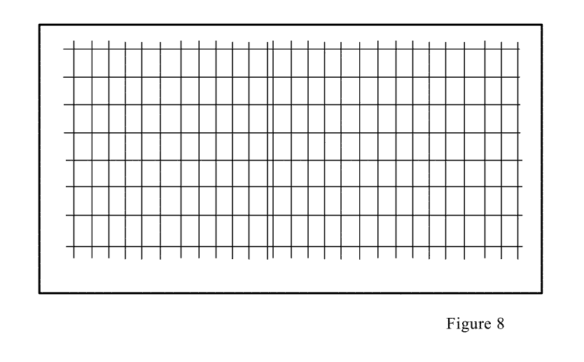

FIG. 8 illustrates a top view of the insulating cover 23. As illustrated the top surface of the insulating cover 23 is provided with a grid 50. In an embodiment (not illustrated) a similar grid is provided on the cover plate 24 which is opaque.

Molded components of the decorating device are made from polycarbonate. The cover plate is made from acrylic.

It is to be realized that embodiments of the invention do not necessarily have to be used for the application of metallic film. The stamping plate main body (20) may be used for stamping, cutting or embossing when used with the appropriate materials, dies and/or stencils.

Although the present disclosure has been disclosed above with reference to preferred embodiments thereof, it should be understood by those skilled in the art that various changes may be made without departing from the spirit or scope of the disclosure. Accordingly, the present disclosure is not limited to the embodiments disclosed.

1. A decorating device, comprising:
a charging point and a stamping plate main body,
wherein the stamping plate main body is detachably installed on the charging point and comprises a heating plate, and a cover plate,
wherein the device is adapted to receive a stamping template and a foil laid from the bottom to the top in order between the heating plate and the cover plate, and
wherein the stamping plate main body is dimensioned to fit a stamping, cutting or embossing press.

2. The decorating device according to claim 1, wherein the stamping plate main body has a height between 20 mm and 32 mm, and a width between 80 mm and 240 mm.

3. The device according to claim 1, wherein one or both of the stamping plate main body and the cover plate have a grid.

4. The device according to claim 1, wherein the heating plate comprises one or more heating elements.

5. The device according to claim 1, wherein the cover plate is detachably connected to the stamping plate main body.

6. The device according to claim 5, wherein the cover plate is connected to the stamping plate main body by a hinge.

7. The device according to claim 1, further comprising a charging base having the charging point.

8. The device according to claim 7, wherein a surface of the charging base is formed with an accommodating space for accommodate the stamping plate main body, an inner wall of a side of the accommodating space is provided with an insertion groove structure for receiving the heating plate of the stamping plate main body.

9. The device according to claim 8, wherein one end of the stamping plate main body is provided with an insertion tenon structure engaged with the insertion groove structure, the insertion tenon structure being provided with a pin for rotationally connecting the stamping plate main body to the cover plate.

10. The device according to claim 9, wherein one end of the cover plate is provided with a convex structure which matches the gap between two adjacent insertion tenon structures, and the bottom of the convex structure is further provided with an axle hole for rotationally receiving the pin.

11. The device according to claim 10, wherein the convex structure is formed downwardly from a plane of the cover plate.

12. The device according to claim 7 comprising a hinge, wherein the hinge is arranged to engage with the charging base when in an open position to thereby lock the stamping plate main body to the charging base.

13. The device according to claim 7, wherein the charging base is provided with an on-off button.

14. The device according to claim 7, wherein the charging base is further provided with an indicator light.

15. The device according to claim 7, wherein the charging base is further provided with a power supply interface.

16. The device according to claim 1, wherein the heating plate is a silica gel plate provided with a heating wire therein, the heating wire and the silica gel plate being integrally molded.

17. The device according to claim 1, wherein an end of the stamping plate main body is provided with a handle.
